(19) United States
(12) Patent Application Publication
(10) Pub. No.: US 2006/0256374 A1
(43) Pub. Date: Nov. 16, 2006

(54) Confidential document printing apparatus and associated print control method

(75) Inventor: Toshihiro Shima, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/390,435

(22) Filed: Mar. 28, 2006

(30) Foreign Application Priority Data
Mar. 29, 2005 (JP) 2005-94690

(51) Int. Cl. G06F 3/12

(52) U.S. Cl. 358/1.15

(57) ABSTRACT

This invention provides a print control method of controlling a print job process. The method includes a control step of transmitting print job data for an execution of a print job to a printing apparatus connected to a network via the network, for controlling the print job process in the printing apparatus. The control step includes the step of suspending the print job process at a time of an initiation of the print job process such that the print job process can be resumed via user input to the printing apparatus.

### BACKGROUND OF THE INVENTION

1. Field of the Invention

The present invention relates to a technology for executing highly secret printing by transmitting print jobs to a printing apparatus that is networked to a plurality of clients.

2. Description of the Related Art

In recent years, the sharing of a plurality of printers connected to the same network by a plurality of client systems has become increasingly common. At the same time, a printer having a so-called confidentiality function used for printing of confidential documents in such an environment has been proposed (e.g. Japanese Patent No. 3444514, JP-A-7-098691, JP-A-6-004238, JP-A-2003-039751, JP-A-2002-149366).

However, it is commonly understood to persons with knowledge of the prior art that a hardware-based confidential printing function must be installed on the printer in order to execute so-called confidential printing. Specifically, this confidential printing function comprises an interface function used for PIN number input or a data storage area in which confidential printing jobs can stand by, for example.

### SUMMARY OF THE INVENTION

The present invention was devised in order to address this issue, and an object thereof is to provide a technology that enables highly secret documents to be printed using a simple system.

This invention provides a print control method of controlling a print job process. The method includes a control step of transmitting print job data for an execution of a print job to a printing apparatus connected to a network via the network, for controlling the print job process in the printing apparatus. The control step includes the step of suspending the print job process at a time of an initiation of the print job process such that the print job process can be resumed via user input to the printing apparatus.

According to the print controller of the present invention, because print job processing can be suspended at the time that processing of such print job is initiated such that the processing can be resumed via user input to the printing apparatus, printed documents can be obtained via prescribed user input to the printer. As a result, printed documents can be reliably obtained while limiting third party access thereto.

The present invention may comprise a printing method, a print control method, a computer program, or a recording medium on which such program is recorded. Where the invention comprises a computer program or a recording medium on which such program is recorded, the program may comprise a program that controls the entire printing apparatus or a program that executes only the functions of the present invention. Furthermore, the recording medium may comprise any of various types of computer-readable media, including a flexible disk, CD-ROM, DVD-ROM, opto-magnetic disk, IC card, ROM cartridge, punch card, printed matter on which a bar code or the like is imprinted, or an internal storage device for a computer (i.e., a memory such as a RAM or ROM) or an external storage device.

### BRIEF DESCRIPTION OF THE DRAWINGS

FIG. 1 is an explanatory drawing showing the basic construction of a printing system 1000 comprising an embodiment of the present invention;

FIG. 2 is an explanatory drawing showing the contents of the confidential printing process of the embodiment of the present invention;

FIG. 3 is an explanatory drawing showing in a conceptual fashion the configuration of communication data including normal print job data in the embodiment of the present invention;

FIG. 4 is an explanatory drawing showing in a conceptual fashion the configuration of communication data including confidential print job data in the embodiment of the present invention; and

FIG. 5 is a graphical user interface screen that provides notification that preparation for confidential printing has been completed.

### DESCRIPTION OF THE PREFERRED EMBODIMENT

Embodiments of the present invention will be described below in the following sequence based on examples.

A. Configuration of a printing system of embodiment of the invention

B. Confidential printing process executed by embodiment of the invention

C. Variations

A. Configuration of Printing System of Embodiment of the Invention

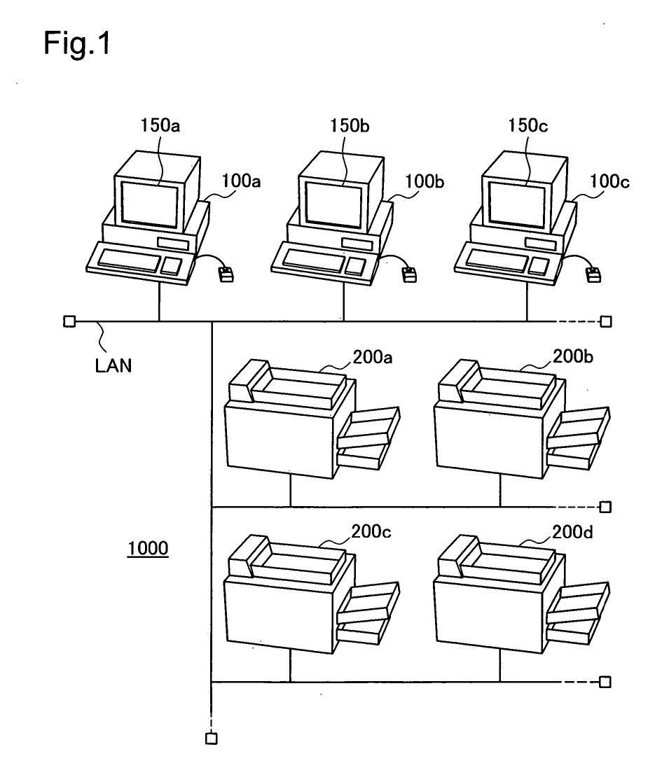

FIG. 1 is an explanatory drawing showing the basic construction of a printing system 1000 comprising an embodiment of the present invention. This printing system 1000 includes three personal computers 100a, 100b, 100c and four printers 200a, 200b, 200c, 200d. These devices are all connected over a local area network LAN. All of the four printers 200a-200d have the identical configuration.

The three personal computers 100a-100c can execute print processing with respect to any of the four printers 200a-200d. In this environment, because a plurality of users can share a single printer, it may be anticipated that a confidential printed document could be accidentally be included in a different user's document or be mistakenly seen by a different user.

B. Confidential Printing Process Executed by Embodiment of the Invention

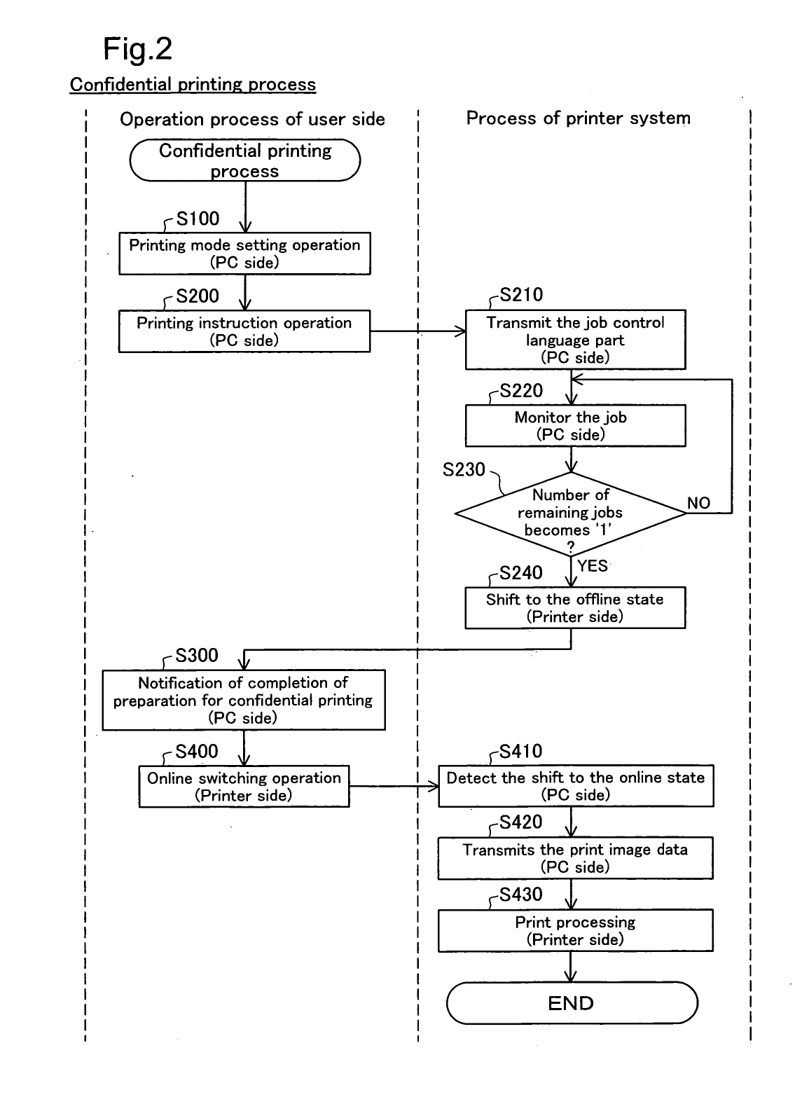

FIG. 2 is an explanatory drawing showing the contents of a confidential printing process [executed according to] an embodiment of the present invention. The confidential printing process of this embodiment is a printing output process in which the possibility of a person other than the person carrying out the confidential printing process accessing the document is controlled. This confidential printing process is realized via the method described below.

In step S100, the user carries out a printing mode setting operation. A printing mode setting operation comprises an operation that sets such matters as the print quality and whether confidential printing is to be performed. This operation is executed on a print mode setting screen that is displayed on the display 150a of the personal computer 100a but is not shown in the drawings. Here, it will be assumed that ‘confidential printing’ has been designated.

In step S200, the user carries out a printing instruction operation on the personal computer 100a. A printing instruction operation is an operation that commands a specified printer to perform printing output. When this operation is executed, if ‘confidential printing’ has not been designated, the normal print job data comprising a normal print job is sent to the printer, though this is not shown in the drawing. If ‘confidential printing’ has been designated, on the other hand, step S210 is carried out.

In step S210, the personal computer 100a transmits the job control language part of the print job data. In this embodiment, the job control language part is transmitted to the printer 200a. The job control language part is the portion of the data used to control the printing of the print image data, comprising the number of prints to be made, for example.

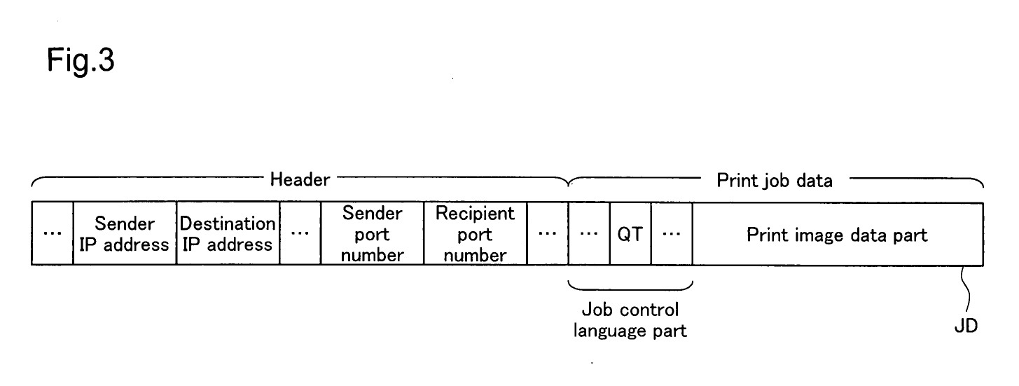

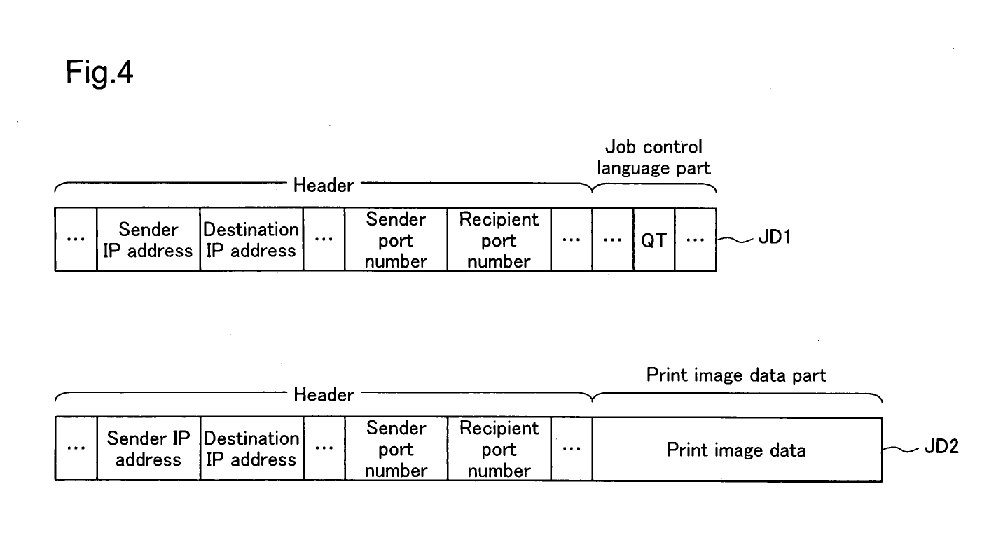

FIG. 3 is an explanatory drawing showing in a conceptual fashion the configuration of communication data that includes normal print job data JD in the embodiment of the present invention. FIG. 4 is an explanatory drawing showing in a conceptual fashion the configuration of communication data that includes confidential print job data in the embodiment of the present invention. Communication data is divided generally into a header and print job data. Print job data is further divided into a job control language part JD1 and a print image data part JD2.

The header includes the IP address of the personal computer 100a (the sender IP address), the port number that specifies the software in the personal computer 100a comprising the sender (the sender port number), the IP address of the printer 200a (the destination IP address) and the port number that specifies the software in the printer 200a comprising the recipient (the recipient port number).

In this embodiment, because TCP/IP is used as the communication protocol, the communication data is normally transmitted in packets. Therefore, in actual practice, because a set of print job data is divided into packets, the header described above is attached to the beginning of each data packet sent separately.

After transmission of the job control language part JD1, the personal computer 100a maintains the connection between itself and the printer 200a in a state in which the print image data part JD2 can be transmitted at any time following transmission of the job control language part JD 1.

In step S220, the personal computer 100a begins to monitor the job list for the printer 200a. This job list monitoring is continued until the number of remaining jobs becomes ‘1’, in order to detect the commencement of print processing for a confidential print job (step S230).

Since the connection between the personal computer 100a and the printer 200a is maintained even after the job control language part is sent, the commencement of print processing for a confidential print job can be detected by the remaining job number becoming ‘1’ because the confidential print job is the final remaining print job.

In step S240, the personal computer 100a controls the printer 200a to shift it to the offline state. This change in state is effected, for example, by the personal computer 100a unicasting to the printer 200a an SNMP packet that includes a command that sets it to the offline state.

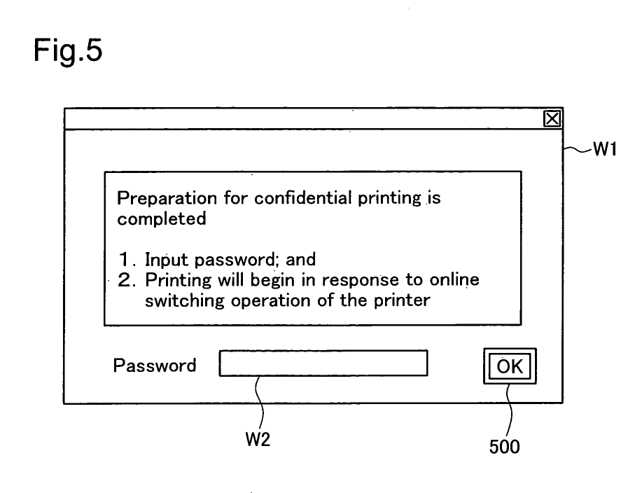

In step S300, the personal computer 100a displays on the display 150a (FIG. 1) of the personal computer 100a a graphical user interface screen (FIG. 5) that, in response to confirmation of the offline setting described above, provides notification that preparation for confidential printing has been completed. From this, the user can see that a confidential print document (hereinafter a ‘confidential document’) can be obtained by executing on the printer 200a an operation to switch the printer 200a from the offline state to the online state.

In this embodiment, the graphical user interface screen (FIG. 5) requires password input. This requirement exists in order to prevent a third party from obtaining the confidential document where the confidential job is pending and the person who ordered the printing has left the area temporarily. Password input in this embodiment is carried out via input into the window 2 using a keyboard not shown and clicking the button 500.

However, a construction is preferred in which a finite time period (for example, three minutes) is set as the period during which print processing by the printer 200a is suspended. The reason for this is that, because other users cannot use the printer while print processing is suspended, where a person outputting a confidential document is to be absent for an excessively long time, it is preferable to open up the printer to other users. Furthermore, a construction is preferred wherein when the printer is to be made available to other users, i.e., after the prescribed finite time period has elapsed, the confidential print job is deleted in order to maintain confidentiality.

In step S400, the user executes the online switching operation on the printer 400. In step S410, the personal computer 100a checks at prescribed time intervals using SNMP, for example, to detect whether the online switching operation has been executed on the printer 200a.

In step S420, the personal computer 100a transmits to the printer 200a the print image data JD2 (FIG. 4) in response to the detection of an online (switching) operation. In step S430, the printer 200a resumes and completes print processing in accordance with the sent print image data JD2.

In this way, the embodiment of the present invention enables print processing on a printer, on which no hardware-based or software-based confidential printing function is installed, to be controlled such that the possibility of a third party accessing a confidential document is minimized. As a result, printing of a confidential document can be safely carried out even in an environment in which a plurality of client systems share a plurality of printers connected to the same network.

C. Variations

The present invention is not limited to the embodiment and examples described above, and may be realized in various other forms within the essential scope of the invention.

C-1. In the above embodiment, print processing was suspended by taking the printer offline, but a construction may be adopted in which, for example, the client system suspends print processing while keeping the printer in an online state, monitors the printer for a change in the printer's state from online to offline, and causes print processing to be resumed upon detecting such a change in state. Using this construction, because it cannot be determined externally that a confidential printing print job is being processed by the printer, confidentiality can be further protected. In addition, the risk of a third party unintentionally accessing a confidential document by setting the printer to an online state can be eliminated.

A construction may be adopted in which user input is carried out using hardware installed on the printer for a different purpose, such as by using a card reader or USB memory used to collect printing fees.

C-2. In the above embodiment, the commencement of print processing of a confidential print job is detected by the number of remaining jobs in a monitored printer job list becoming ‘1’, but a construction may be adopted in which, for example, the client system uses the names of the jobs in the job list to monitor whether or not the confidential job's turn for processing has arrived.

C-3. In the above embodiment, print processing is suspended by sending only the print control data to the printer, but a construction may be adopted in which, for example, the client system includes in the print job data a control command to suspend print processing of the print job. In general, any construction of the present invention is acceptable so long as suspension of print job processing is executed at the outset of processing of a confidential document in such a way that printing may be resumed via user input.

C-4. In the above embodiment, the printers had no hardware-based or software-based confidential printing function installed, but a confidential printing function based solely on software, for example, may be installed. If a software-based function is used, the present invention can be realized simply by updating the firmware.

Specifically, the printer may have a construction in which, where a print job is transmitted with the specification of a particular port number or based on a particular protocol, for example, processing of the print job is suspended at the outset thereof such that it may be resumed via user input to the printer. With such a printer, the client system can carry out confidential printing simply through the use of a particular print protocol or port number.

Finally, the present application claims the priority based on Japanese Patent Application No. 2005-094690 filed on Mar. 29th 2005, which are herein incorporated by reference.

What is claimed is:

1. A printing system, comprising:
a print controller for controlling a print job process; and
a printing apparatus, wherein
the print controller includes:
a control unit that transmits print job data for an execution of a print job to a printing apparatus connected to a network via the network, for controlling the print job process in the printing apparatus, wherein
the control unit is configured to suspend the print job process at a time of an initiation of the print job process such that the print job process can be resumed via user input to the printing apparatus, wherein
the printing apparatus includes:
a print processing unit that processes a printing process, in response to a print job transmitted via a network, wherein
the print processing unit is configured to suspend the print job process at the time of the initiation of the print job process such that the print job process can be resumed via the user input to the printing apparatus when the transmitted print job is at least one of a first type print job and a second type print job, the first type print job being a print job with a designation of a particular port, the second type print job being a print job based on a particular print protocol.

2. A print control method of controlling a print job process, comprising:
a control step of transmitting print job data for an execution of a print job to a printing apparatus connected to a network via the network, for controlling the print job process in the printing apparatus, wherein
the control step includes the step of suspending the print job process at a time of an initiation of the print job process such that the print job process can be resumed via user input to the printing apparatus.

3. The print control method according to claim 2, wherein
the control step includes the step of switching a status of the printing apparatus to offline, for suspending the print job process, wherein
the user input comprises an input operation performed to the printing apparatus, for switching the status of the printing apparatus to online.

4. The print control method according to claim 2, wherein
the control step includes the step of monitoring an order of print jobs to determine a turn of the print job, for controlling the printing apparatus to suspend the print job process in response to the determination of the turn.

5. The print control method according to claim 2, wherein
the control step includes the step of including a control command to suspend the print job process into the print job data.

6. The print control method according to claim 2, wherein
the print job data includes print image data and print control data, the print image data being indicative of a print image to be printed with the print job, the print control data being used to control printing with the print image data, wherein
the control step includes the steps of:
suspending the print job process by transmitting only the print control data to the printing apparatus; and
resuming the print job process by transmitting the print image data to the printing apparatus, in response to the user input.

7. The print control method according to claim 2, wherein
the control step includes the steps of:
setting a prescribed finite time period as a period for the suspension of the print job process; and
canceling the print job process automatically if the prescribed finite time period elapses.

8. The print control method according to claim 2, wherein
the control step includes the step of providing a graphical user interface that informs a readiness of resuming the print job process, in response to the suspension of the print job process.

9. The print control method according to claim 8, wherein
the control step includes the step of requesting the user to input a password for resuming the print job process.

10. The print control method according to claim 2, wherein
the control step includes the steps of:
suspending the print job process while keeping a status of printing apparatus online;
monitoring for a status change of the printing apparatus from online to offline, for detecting the status change; and
resuming the print job process in response to the detection of the status change.

11. A print controller for controlling a print job process, comprising:
a control unit that transmits print job data for an execution of a print job to a printing apparatus connected to a network via the network, for controlling the print job process in the printing apparatus, wherein
the control unit is configured to suspend the print job process at a time of an initiation of the print job process such that the print job process can be resumed via user input to the printing apparatus.

12. A computer program product for causing a computer to control a print job process, the computer program product comprising:
a computer readable medium; and
a computer program stored on the computer readable medium, the computer program comprising:
a program for causing the computer to transmit print job data for an execution of a print job to a printing apparatus connected to a network via the network, for controlling the print job process in the printing apparatus, wherein
the program includes a program for causing the computer to suspend the print job process at a time of an initiation of the print job process such that the print job process can be resumed via user input to the printing apparatus.

13. A printing method, comprising:
a print processing step of processing a printing process, in response to a print job transmitted via a network, wherein
the print processing step includes the step of suspending the print job process at a time of an initiation of the print job process such that the print job process can be resumed via user input to the printing apparatus when the transmitted print job is at least one of a first type print job and a second type print job, the first type print job being a print job with a designation of a particular port, the second type print job being a print job based on a particular print protocol.

14. A printing apparatus, comprising:
a print processing unit that processes a printing process, in response to a print job transmitted via a network, wherein
the print processing unit is configured to suspend the print job process at a time of an initiation of the print job process such that the print job process can be resumed via user input to the printing apparatus when the transmitted print job is at least one of a first type print job and a second type print job, the first type print job being a print job with a designation of a particular port, the second type print job being a print job based on a particular print protocol.

15. A computer program product for controlling a printing apparatus, the computer program product comprising:
a computer readable medium; and
a computer program stored on the computer readable medium, the computer program comprising:
a program for causing a printing apparatus to process a printing process, in response to a print job transmitted via a network, wherein
the printing apparatus is configured to suspend the print job process at a time of an initiation of the print job process such that the print job process can be resumed via user input to the printing apparatus when the transmitted print job is at least one of a first type print job and a second type print job, the first type print job being a print job with a designation of a particular port, the second type print job being a print job based on a particular print protocol.
